(19) United States
(12) Patent Application Publication
(10) Pub. No.: US 2016/0107571 A1
(43) Pub. Date: Apr. 21, 2016

(54) INTEGRATED DECK LID MODULE FOR A MOTOR VEHICLE

(71) Applicant: FORD GLOBAL TECHNOLOGIES, LLC, Dearborn, MI (US)

(72) Inventors: Paul Kenneth Dellock, Northville, MI (US); Harry Lobo, Canton, MI (US); Stuart C. Salter, White Lake, MI (US); Talat Karmo, Waterford, MI (US)

(21) Appl. No.: 14/516,051

(22) Filed: Oct. 16, 2014

(51) Int. Cl. B60R 1/00; H04N 5/225; H04N 7/18

(52) U.S. Cl. CPC B60R 1/00; H04N 7/183; H04N 5/2256

(57) ABSTRACT

An integrated deck lid module is provided. That module includes a single circuit board for the light source to illuminate the license plate, an integrated camera chip, camera control hardware and a single electrical connector for all of these components.

### TECHNICAL FIELD

This document relates generally to the vehicle equipment field and, more particularly to an integrated deck lid module for a motor vehicle.

### BACKGROUND

Today, motor vehicles such as passenger cars, minivans, sports utility vehicles and crossover vehicles, commonly include license plate lamps and backup cameras that are housed in separate housings and that are connected to each other and/or the vehicle with complex wiring harnesses. All of these individual components are attached either directly to the sheet metal deck lid or a plastic component like the rear deck lid appliqué.

Unfortunately, these separate component modules and wiring harnesses add variable cost, investment and assembly costs to the motor vehicle. Further, the multiple wiring attachments and harnesses create potential for miss-builds and other quality issues.

This document relates generally to an integrated deck lid module wherein the license plate lamps, integrated camera chip, camera control hardware, electrical connector and other components are all provided on a single circuit board. As a result various components are eliminated including jumper harnesses, lamp housings, separate camera, camera bezel and various retainer brackets. Advantageously, the solid-state design of the integrated deck lid module improves reliability, eliminates connectors and connections to camera switches and lamps reduces or eliminates the chance for miss-assembly and also reduces assembly labor costs.

### SUMMARY

In accordance with the purposes and benefits described herein, an integrated deck lid module is provided. The integrated deck lid module comprises a single circuit board including: (a) a light source to illuminate a license plate, (b) an integrated camera chip, (c) camera control hardware, and (d) an electrical connector. In one possible embodiment, the single circuit board further includes a deck lid release switch. Still further the module includes a single housing.

The housing includes a lens to direct light from the light source onto the license plate. Further the housing includes a window for the camera. In addition the housing may also include an optional actuator for the optional deck lid release switch.

In one possible embodiment the light source for illuminating the license plate is an LED which is more reliable than an incandescent bulb.

In accordance with an additional aspect, a method is provided for integrating deck lid operating systems and reducing the complexity of those systems along with the component costs and assembly costs. The method may be broadly described as comprising the step of providing (a) a light source for illuminating a license plate, (b) an integrated camera chip, (c) camera control hardware and (d) an electrical connector all on a single circuit board. In addition, the method may be further described as including the step of providing a deck lid release switch on the single circuit board. Further the method includes covering the single circuit board with a housing thereby providing a single module for multiple deck lid operating systems. In accordance with still another aspect, a vehicle is provided incorporating the integrated deck lid module described herein.

In the following description, there are shown and described several preferred embodiments of the integrated deck lid module. As it should be realized, the module is capable of other, different embodiments and its several details are capable of modification in various, obvious aspects all without departing from the module as set forth and described in the following claims. Accordingly, the drawings and descriptions should be regarded as illustrative in nature and not as restrictive.

### BRIEF DESCRIPTION OF THE DRAWING FIGURES

The accompanying drawing figures incorporated herein and forming a part of the specification, illustrate several aspects of the integrated deck lid module and together with the description serve to explain certain principles thereof. In the drawing figures:

FIG. 1 is a perspective view of the deck lid of a vehicle incorporating the integrated deck lid module that is the subject of this document.

FIG. 2 is a detailed perspective view of the exterior of the integrated deck lid module housing.

FIG. 3 is a front plan view of the single circuit board of the integrated deck lid module that is held inside the housing illustrated in FIG. 2.

Reference will now be made in detail to the present preferred embodiments of the integrated deck lid module, examples of which are illustrated in the accompanying drawing figures.

### DETAILED DESCRIPTION

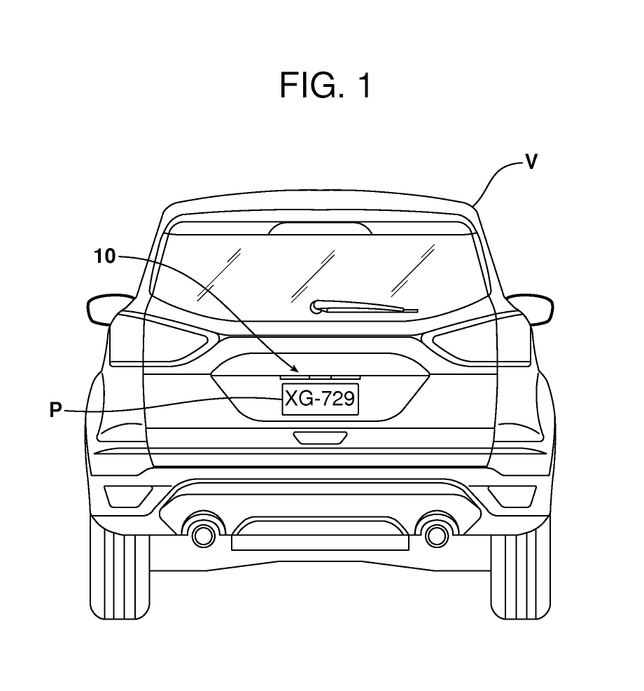

Reference is now made to FIG. 1 illustrating a vehicle V including a deck lid D equipped with the integrated deck lid module 10. While the illustrated vehicle V is a sports utility vehicle, it should be appreciated that the integrated deck lid module 10 may be utilized on substantially any motor vehicle including, for example, sports utility vehicles, crossover utility vehicles, minivans and passenger cars. For purposes of this document, the terminology “deck lid” includes trunk lids, hatch-back lids, tailgates or any other structure at the rear of the vehicle associated with or carrying a license plate P.

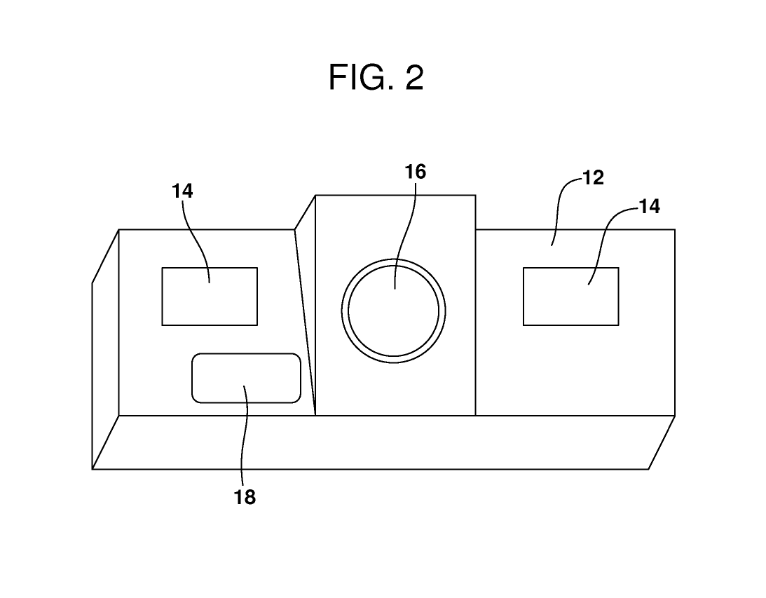

Reference is now made to FIG. 2 illustrating the housing 12 of the integrated deck lid module 10. In one possible embodiment, the housing 12 is injection molded from plastic material suitable for protecting the components contained therein from the elements.

As illustrated, the housing 12 may include one or more license plate lamp lenses 14. The housing 12 may also include an angled camera window 16. Still further, the housing 12 may include a trunk/deck lid release switch actuator 18 in the event the vehicle V is equipped with such a switch.

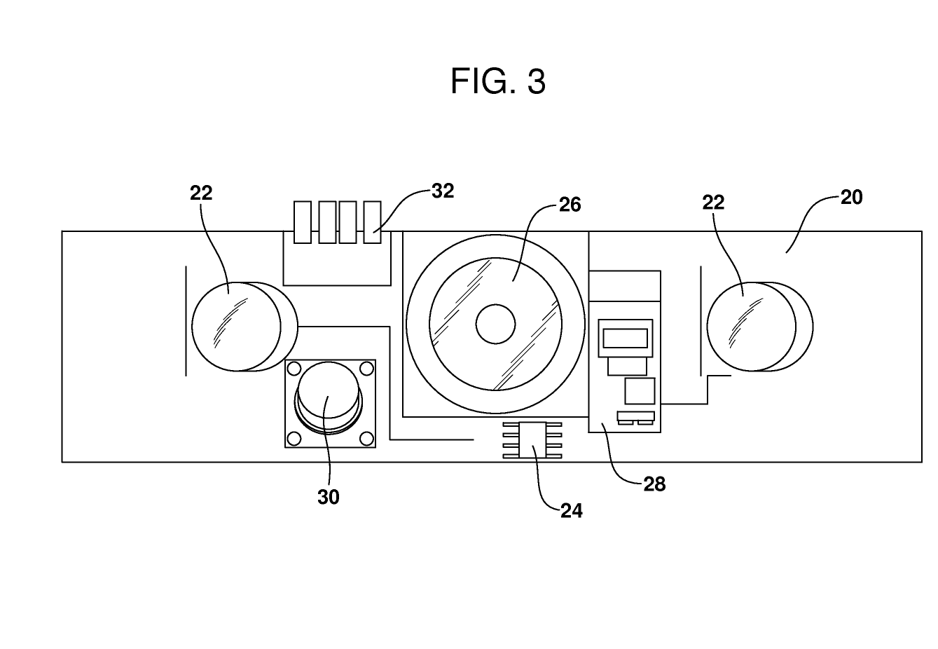

Reference is now made to FIG. 3 illustrating the single circuit board 20 of the integrated deck lid module 10 that is contained within and protected by the housing 12. The circuit board 20 includes one or more light sources 22 that illuminate the adjacent license plate P with light directed through license plate lamp lenses 14 in the housing 12. In one possible embodiment the light sources 22 may take the form of light emitting diodes (LEDs). Such LEDs 22 are typically more reliable and last longer than incandescent bulbs. It should be appreciated, however, that incandescent bulbs or other light sources may be utilized if desired.

The circuit board 20 also includes an integrated, electronic camera chip 24 and camera lens 26 along with camera control hardware 28. When properly received and mounted within the housing 12, it should be appreciated that the camera lens 26 is aligned with the camera window 16 in the housing so as to allow a clear field of view behind the vehicle to aid the vehicle operator when backing up in parking lots and other areas.

As further illustrated in FIG. 3, the circuit board 20 may also include an optional trunk/deck lid release switch 30 to allow one to electronically open the trunk or deck lid. The release switch can be either a capacitive or a mechanical switch. When the circuit board 20 is properly mounted within the housing 12, the release switch actuator 18 is aligned with the release switch 30 so that the vehicle operator may depress the actuator to open the trunk or deck lid.

As further illustrated in FIG. 3, the circuit board 20 also includes an electrical connector 32 which may be connected by means of a single wiring harness (not shown) to power all of the components provided on the circuit board 20. For purposes of this document the terminology “electrical connector” includes an electrical connector secured directly to the circuit board 20 as illustrated or an electrical wiring harness attached directly to the board.

As should be appreciated, a method of integrating deck lid operating systems and reducing the complexity, component cost and assembly costs of the motor vehicle V is also provided. This method includes providing (a) a light source, such as the two illustrated LEDs 22, for illuminating the license plate P, (b) an integrated camera chip 24, (c) an associated camera lens 26 and (d) camera control hardware 28 on a single circuit board 20. Further, the method includes providing an electrical connector 32 for providing a single electrical connection to all of the components on the circuit board 20.

In one possible embodiment the method includes providing a deck lid release switch 30 on the circuit board 20. Further, as illustrated in FIGS. 1-3, the method also includes covering the single circuit board 20 with a single housing 12 so as to provide a single module for multiple deck lid operating systems including, for example, the license plate illumination system, the backup camera system, and the trunk or deck lid release system.

The foregoing has been presented for purposes of illustration and description. It is not intended to be exhaustive or to limit the embodiments to the precise form disclosed. Obvious modifications and variations are possible in light of the above teachings. All such modifications and variations are within the scope of the appended claims when interpreted in accordance with the breadth to which they are fairly, legally and equitably entitled.

What is claimed:

1. An integrated deck lid module, comprising:
a single circuit board including;
(a) a light source to illuminate a license plate;
(b) an integrated camera chip;
(c) camera control hardware; and
(d) an electrical connector.

2. The module of claim 1, wherein said single circuit board further includes a deck lid release switch.

3. The module of claim 2, further including a housing.

4. The module of claim 3, wherein said housing includes a lens to direct light from said light source onto said license plate.

5. The module of claim 4, wherein said housing further includes a window for said camera.

6. The module of claim 5, wherein said housing further includes an actuator for said deck lid release switch.

7. The module of claim 6, wherein said light source is an LED.

8. The module of claim 1, further including a housing.

9. The module of claim 8, wherein said housing includes a lens to direct light from said light source onto said license plate.

10. The module of claim 9, wherein said housing further includes a window for said camera.

11. The module of claim 10, wherein said housing further includes an actuator for said deck lid release switch.

12. The module of claim 11, wherein said light source is an LED.

13. A method of integrating deck lid operating systems and reducing complexity, component costs and assembly costs, comprising:
providing (a) a light source for illuminating a license plate, (b) an integrated camera chip, (c) camera control hardware and (d) an electrical connector all on a single circuit board.

14. The method of claim 13, further providing a deck lid release switch on said single circuit board.

15. The method of claim 13, including covering said single circuit board with a housing thereby providing a single module for multiple deck lid operating systems.

16. A vehicle incorporating the integrated deck lid module of claim 1.
